(19) United States
(12) Patent Application Publication
(10) Pub. No.: US 2003/0131523 A1
(43) Pub. Date: Jul. 17, 2003

(54) Particle injecting fire ant eradication device and method

(76) Inventor: Hugh Miller Rawls, Maaianna, FL (US)

Correspondence Address: John Wiley Horton, Attorney, Pennington, Moore, Wilkinson, Bell & Dunbar, P.A., 2nd Floor, 215 S. Monroe St., Tallahassee, FL, 32301, US

(21) Appl. No.: 10/042,363

(22) Filed: Jan. 11, 2002

(51) Int. Cl. A01M 1/20; A01M 5/00; A01M 7/00; A01M 17/00

(52) U.S. Cl. 43/132.1

(57) ABSTRACT

A method and apparatus for eradicating fire ants by permeating the soil in a fire ant mound with very small particles. These particles tend to infiltrate and disable the joint structure of the ants, eventually killing them. One particularly effective composition is diatomaceous clay—commonly known as fuller's earth.

The invention incorporates a pump which pressurizes water and feeds it into a mixer. The mixer adds a continuous stream of fuller's earth, which mixes with the water to form a colloid. The pressurized mixture is then fed through a flexible line to a user-held injector assembly. The injector assembly incorporates an elongated reciprocating shaft, on the end of which is a probe. The user thrusts the probe into an ant mound occupied by the fire ants. The colloid of water and fuller's earth is then injected through a central passageway within the reciprocating shaft into the probe. A series of venturi are situated around the probe. These allow the colloid to shoot out into the surrounding soil once the probe is in place.

Because it is often difficult to thrust the probe into the mound, another feature is included: The user-held injector assembly incorporates a cyclic valve admitting the pressurized water to a reciprocating shaft. The reciprocating shaft is free to move back and forth in a direction along its central axis. When the user admits the pressurized colloid to the injector assembly by pressing a trigger, the cyclic valve causes the reciprocating shaft to pulse forward and backward rapidly. This action assists the user in thrusting the probe into the ant mound, and also assists in the distribution of the colloid in the ant mound.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the destruction of imported fire ants of the genus solenopsis invicta, and specifically to an apparatus which destroys the ants by injecting small particles into the soil.

2. Description of the Related Art

The South American fire ant has been a problem in the United States since the early part of the twentieth century. It has been tremendously successful in expanding its habitat at the expense of other indigenous ants. The fire ant's success is largely due to the following documented characteristics: (1) Any disturbance of the fire ant mound will cause the colony to attack the intruder in mass; (2) Any disturbance sufficient to destroy the mound will cause the ants to rapidly transport the queen to safety through a series of underground tunnels extending outwards for as much as 75 feet; and (3) So long as the queen and a few thousand ants survive the attack, a new mound may rapidly be established.

Various methods have been employed to kill an ant colony. One known technique is to insert a probe into the mound and inject vaporized insecticides, as shown in the U.S. Pat. No. 4,756,118 to Evans (1988). Another method is to flood the mound with insecticides dissolved in water, as shown in U.S. Pat. No. 5,054,231 to Witherspoon (1991). Both these methods depend on the user manually thrusting the probe into the mound, which requires substantial strength and often limits the depth of penetration. Some ant colonies bury the queen three or more feet below ground level, meaning that the methods shown in the '118 and '231 patents may have difficulty destroying the queen before she can be removed. The '118 and '231 devices also employ active insecticides. The environmental drawbacks inherent in the use of such chemicals are well documented.

Various prior art devices can be used to aid the insertion of a probe into the ground. My own prior U.S. Pat. No. 6,026,609 (2000) discloses the use of a hydraulic ram to insert a probe. U.S. Pat. No. 3,886,874 to Platz (1975) discloses the use of an impact hammer (often called a “jackhammer”) to ram a probe into the soil. The Platz device typically requires a high-pressure air line as its power source. Those skilled in the art will know, however, that lighter duty devices are available. For instance, “chipping hammers” are often used to remove weld slag in the ship building industry. These are essentially low-impact jackhammers. Older versions are powered by small air lines, while some modern versions use electrically-powered solenoids to provide the reciprocating action. The use of these prior art technologies in the present invention will be explained subsequently.

The known methods for eradicating the South American fire ant are therefore limited in that they: (1) Cannot penetrate very deeply into the mound, possibly preventing the destruction of the queen; (2) Employ insecticides with undesirable environmental effects; and (3) Are fairly slow to operate, thereby giving the colony time to remove the queen.

### BRIEF SUMMARY OF THE INVENTION

The present invention comprises a method and apparatus for eradicating fire ants by permeating the soil in a fire ant mound with very small particles. These particles tend to infiltrate and disable the joint structure of the ants, eventually killing them. One particularly effective composition is diatomaceous clay—commonly known as fuller's earth.

The invention incorporates a pump which pressurizes water and feeds it into a mixer. The mixer adds a continuous stream of Fuller's earth, which mixes with the water to form a colloid. The pressurized mixture is then fed through a flexible line to a user-held injector assembly. The injector assembly incorporates an elongated reciprocating shaft, on the end of which is a probe. The user thrusts the probe into an ant mound occupied by the fire ants. The colloid of water and fuller's earth is then injected through a central passageway within the reciprocating shaft into the probe. A series of venturi are situated around the probe. These allow the colloid to shoot out into the surrounding soil once the probe is in place.

As mentioned previously, it is often difficult to thrust the probe into the mound. The invention incorporates another feature to remedy this problem. The user-held injector assembly incorporates a cyclic valve admitting the pressurized water to the reciprocating shaft. The reciprocating shaft is free to move back and forth in a direction along its central axis. When the user admits the pressurized colloid to the injector assembly by pressing a trigger, the cyclic valve causes the reciprocating shaft to pulse forward and backward rapidly. This action assists the user in thrusting the probe into the ant mound, and also assists in the distribution of the colloid in the ant mound.

Accordingly, several objects and advantages of the present invention are:

1. to insert a probe into an ant mound using the assistance of a reciprocating shaft, whereby a large probe may be thrust three or more feet below the ground level for the delivery of a colloid;

2. to allow a rapid approach and destroy cycle, thereby minimizing warning to the ants;

3. to kill the queen of the ant colony, and as many of the other ants as possible in a short period of time; and

4. to perform these operations without the use of pesticides.

These objects and advantages will be fully explained in the details hereafter described, explained, and claimed, with reference being made to the accompanying drawings.

### DESCRIPTION OF THE SEVERAL VIEWS OF THE DRAWINGS

FIG. 1 is an isometric view, showing the proposed invention.

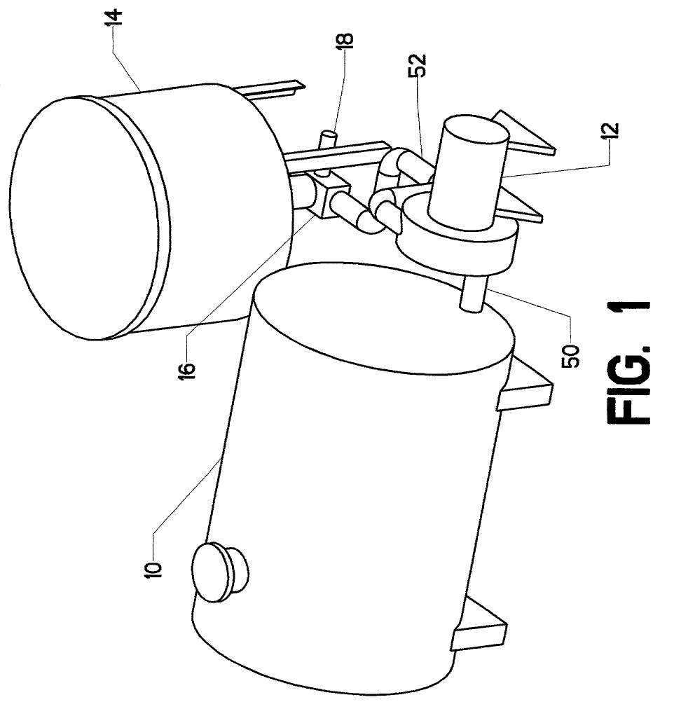

FIG. 2 is an isometric view, showing the injector assembly.

FIG. 3 is an isometric view, showing the probe.

FIG. 4 is an isometric sectional view, showing the internal features of the probe.

FIG. 5 is an isometric view, showing a portable version of the present invention.

### REFERENCE NUMERALS IN THE DRAWINGS

10 water tank

12 pump

14 hopper

16 mixer

18 outlet

20 injector assembly

22 feed line

24 pistol grip

26 side handle

28 trigger

30 hammer assembly

32 reciprocating shaft

34 probe

36 recessed annulus

38 venturi

40 injection manifold

42 hose reel

48 trailer

50 pump inlet

52 discharge line

### DESCRIPTION OF THE INVENTION

1 shows the larger elements of the invention. Water tank 10 holds water to be fed into This allows the invention to be portable for agricultural and other relatively remote applications. However, the use of a tank is not critical. If a different water source is available, it could be used as well.

Water is fed from water tank 10 to pump 12 through pump inlet 50. Pump 12 pressurizes the water, then feeds it to mixer 16 through discharge line 52. Hopper 14 feeds fine particles into mixer 16, where they are injected into the pressurized water to form a colloid. The colloid is then discharged through outlet 18.

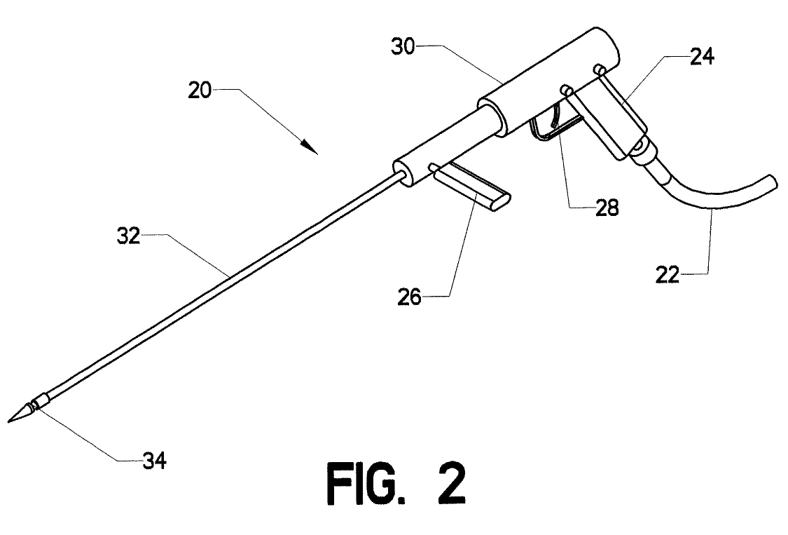

Turning now to FIG. 2, injector assembly 20 will be explained in detail. Feed line 22, which is typically ten feet or more in length, is connected to outlet 18. The pressurized colloid is thereby fed to injector assembly 20. A user grasps injector assembly 20 by pistol grip 24. Side handle 26 is provided for the user's other hand, in order to aid stability. Both pistol grip 24 and side handle 26 are attached to hammer assembly 30.

Reciprocating shaft 32 extends downward to probe 34. In use, the user grasps pistol grip 24 and side handle 26, then thrusts probe 34 into the ground. The user then presses trigger 28. This action allows the flow of the pressurized colloid into hammer assembly 30, down through reciprocating shaft 32, and into probe 34. Probe 34 contains a plurality of venturi which allow the pressurized colloid to escape outward into the surrounding earth.

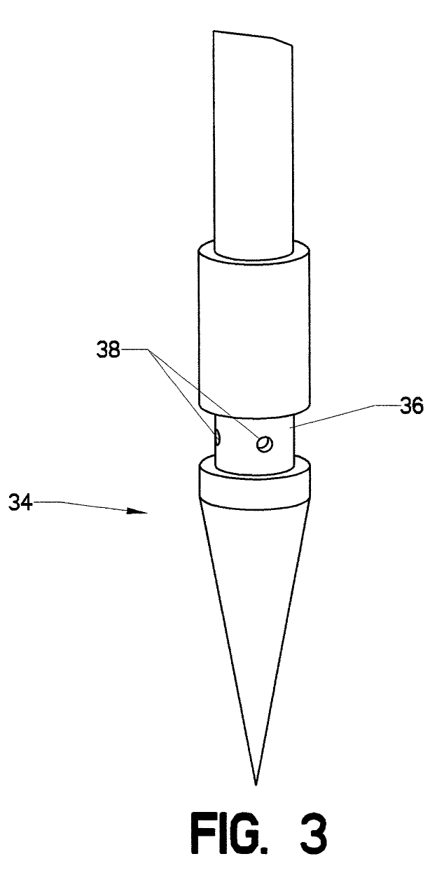

FIG. 3 shows a detail view of probe 34. The reader will observe its pointed lower tip, shaped to facilitate thrusting into the soil. The reader will also observe that its outer cylindrical surface contains recessed annulus 36. A plurality of venturi 38 are arrayed around recessed annulus 36. The recess tends to prevent soil from clogging venturi 38 when probe 34 is thrust into the ground.

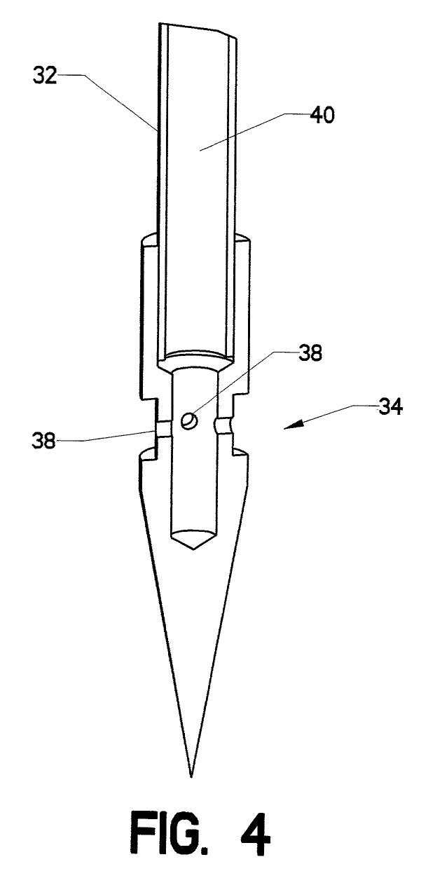

FIG. 4 shows a section view of probe 34. The reader will observe that reciprocating shaft 32 is hollow, forming injection manifold 40 down its center. The interior of probe 34 is likewise hollow, with injection manifold 40 continuing for some distance into its interior. This lower portion of injection manifold 40 opens into a plurality of venturi 38, which exit probe 34.

Thus, those skilled in the art will realize that when the pressurized colloid is introduced into injection manifold 40, it will flow down through reciprocating shaft 32, into probe 34, and out through the plurality of venturi 38. Those skilled in the art will also realize, however, that soil conditions may make the insertion of probe 34 difficult. This is particularly true in hot and dry conditions, where fire ants are common. An additional feature has been added to the invention to remedy this problem.

Returning now to FIG. 2, this additional feature will be explained. Hammer assembly 30 contains a flow control valve which is actuated by trigger 28. In normal operations, pump 12 runs continuously, maintaining the colloid in a pressurized state. Thus, feed line 22 remains pressurized. When the user depresses trigger 28, the colloid flows through the control valve in hammer assembly 30, and then down into injection manifold 40—which is fluidly connected with the control valve.

Hammer assembly 30 also incorporates a cyclic valve which the user can turn on or off as desired. If turned on, the cyclic valve produces a pulsed pressure input to reciprocating shaft 32. Reciprocating shaft 32 is attached to hammer assembly 30 in such a fashion as to be free to move up and down through a limited distance. The cyclic valve moves reciprocating shaft 32 up and down in a rapid, violent motion (with respect to hammer assembly 30). In effect, this action makes injector assembly 20 into a light duty jackhammer. The cyclic valve is preferably slaved to the flow control valve, so that when the user depresses trigger 28, both the colloid flow and the jackhammer action are initiated. The jackhammer action significantly assists the insertion of probe 34 into the ground.

Since many soil conditions will not require the jackhammer action, it is preferable to have the option to turn off the cyclic valve. As both the flow control, cyclic valve, and jackhammer action are well known in the prior art, they will not be described in greater detail.

From the preceding description, the reader will understand that the invention is capable of suspending very fine particles in water to form a colloid. The invention is capable of then shooting this colloid into the ground under substantial pressure. This results in the dispersion of the fine particles in the ground.

If probe 34 is thrust into an ant mound and flow is then initiated, the colloid will be dispersed throughout the loosely packed soil within the mound. Using the jackhammer action, reciprocating shaft 32 can be thrust completely into the mound. It is therefore possible to thrust probe 34 three feet or more below ground level. This depth may be needed, depending upon the prevailing conditions. In cold weather, solenopsis ants may bury the queen to a depth of three feet or even more. Longer reciprocating shafts 32 can be employed if needed.

Once the colloid is injected, the water tends to evaporate and leave the fine particles behind. These particles are of a very small size, much smaller than typical soil particles. They tend to cling to the ants as the ants move through the interior of the mound. The clinging results from simple mechanical interaction, as well as static electricity. Those skilled in the art will know that small particles tend to greatly impede the motion of ants and other insects. Insects have an exoskeletal structure. Their leg joints often expose a gap between adjoining exoskeletal segments. Small particles tend to fill the gaps, greatly impairing the motion of the insect and eventually killing it.

Although many finely particulated substances could be employed in the present invention, diatomaceous clay has been found to be particularly effective (also known as “fuller's earth”). This substance is a naturally occurring soil product. It is typically refined by sifting to produce a very uniform particle size. It produces an excellent colloid—with the particles remaining in suspension for two hours or more. It is also completely inert—meaning that it has no adverse environmental impact. The present invention simply injects water and a natural soil product into the ground.

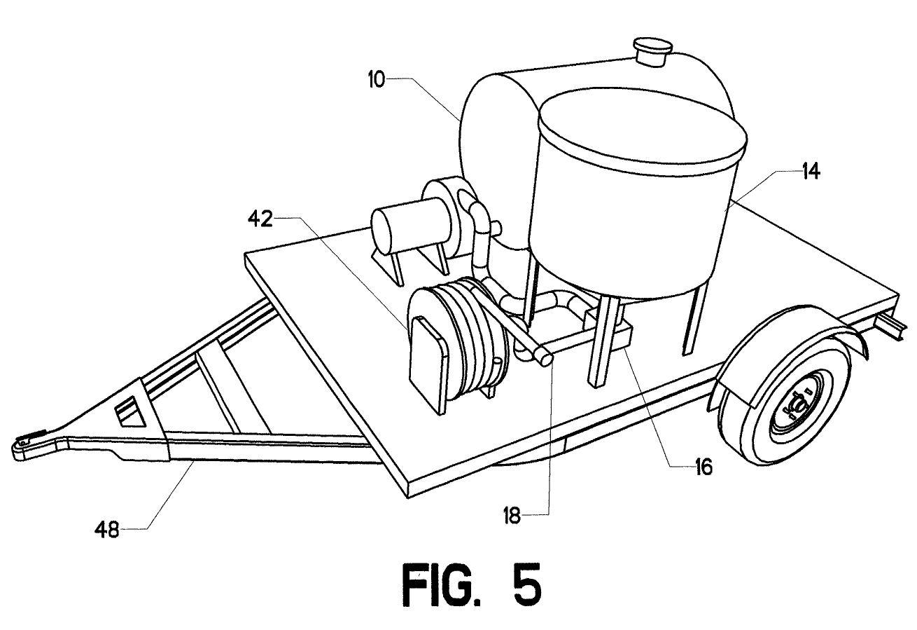

The components described have considerable weight and consideration should be given to making the device portable—since ant mounds are often widely dispersed. FIG. 5 shows the basic components mounted on trailer 48. Water tank 10 feeds into pump 12. Pump 12 feeds into mixer 16, which is situated directly beneath hopper 14. The user may open the top of hopper 14 to load the diatomaceous clay (typically supplied in bags). Hopper 14 may incorporate vibratory feeder and auger mechanisms, both of which are well known in the prior art. Whenever flow is initiated by the user, pressurized water flows through mixer 16. A stream of diatomaceous clay flows from hopper 14 into mixer 16, where it is mixed into the water by a turbulent swirling flow. The result is a pressurized colloid leaving mixer 16.

It is advantageous to provide the user with a length of hose to allow the user to treat several mounds in close proximity. Hose reel 42 is provided for this purpose. The pressurized colloid flows into the hose coiled on hose reel 42, and eventually out to outlet 18. Those skilled in the art will know that as the user tugs on outlet 18, additional hose will unwind from hose reel 42 (the reader will recall that outlet 18 is connected to feed line 22 on injector assembly 20).

Trailer 48 is fitted with a hitch so that it can be towed by a tractor, truck, or ATV. In practical application, the user tows trailer 48 to a position in the center of a number of ant mounts. The user then grasps injector assembly 20 and walks around to treat the different mounds. Hose reel 42 allows the user to extend the position of outlet 18. Hose reel 42 is preferably fitted with a retracting mechanism so that it respools unneeded hose.

During operation, there may be extended periods where the user does not initiate the flow of the colloid. This period of inactivity may cause unwanted wear on the pump (due to maintaining the pump at its shut-off head). It may also cause uneven mixing in mixer 16, since the mixing action typically depends on flow. To remedy this problem, a return line can be added. This return line would start downstream of the mixer and return to pump inlet 30. During the periods when trigger 28 is not depressed, this return line would be activated—producing continuous flow through mixer 16 and ensuring an even colloid.

Those skilled in the art will know that the position of mixer 16 within the fluid circuit is a question of engineering convenience. The colloid could be formed within water tank 10, or in pump inlet 50. The novel features of the invention involve the injecting of the colloid into the ground. The formation of a colloid is well known in the prior art.

Those skilled in the art will also know that the selection of the carrier fluid (water in the preferred embodiment) and the type of particles (diatomaceous clay in the preferred embodiment) is also a question of engineering convenience. However, the inert nature of water and diatomaceous clay make this combination particularly attractive. It is therefore the preferred embodiment.

Accordingly, the reader will appreciate that the proposed invention can readily inject very fine particles into the ground to eradicate ants and other insects. The invention has further advantages in that it:

1. Inserts a probe into an ant mound using the assistance of a reciprocating shaft, whereby a large probe may be thrust three or more feet below the ground level for the delivery of a colloid;

2. Allows a rapid approach and destroy cycle, thereby minimizing warning to the ants; and

3. Does not use pesticides.

Although the preceding description contains significant detail, it should not be construed as limiting the scope of the invention but rather as providing illustrations of the preferred embodiment of the invention. As an example, other pressurizing means could be substituted for the pump employed in the preferred embodiment. Pressurized air could be fed into water tank 10 to pressurize the water lines without the need for a pump. Thus, the scope of the invention should be fixed by the following claims, rather than by the examples given.

Having described my invention, I claim:

1. A device for eradicating fire ants and other insects dwelling in the ground, comprising:
a. a carrier fluid supply supplying a carrier fluid;
b. a mixer for mixing fine particles into said carrier fluid to form a colloid;
c. pressurizing means for pressurizing said colloid;
d. an injector assembly, shaped so as to be easily inserted into said ground, wherein said injector assembly has an injection manifold fluidly connected to said pressurized colloid, and wherein said injection manifold opens into at least one venturi allowing fluid communication with the outside of said injector assembly so that when said injector assembly is thrust into said ground, said pressurized colloid flows out through said at least one venturi and into said ground, so as to disperse said fine particles within said ground, so that said fine particles will become entrapped within the joints of said fire ants and other insects, thereby killing said fire ants and other insects.

2. A device as recited in claim 1, wherein said fine particles consist essentially of diatomaceous earth.

3. A device as recited in claim 1, wherein said carrier fluid consists essentially of water.

4. A device as recited in claim 1, wherein said injector assembly includes a trigger allowing a user to control said flow of said pressurized colloid.

5. A device as recited in claim 3, wherein said injector assembly has an upper portion and a lower portion, including:
a. a probe, located at said lower portion, and having said at least one injection venturi therein;
b. a reciprocating shaft, extending upward from said probe and attached thereto; and
c. a hammer assembly, extending upward from said reciprocating shaft and attached thereto, wherein said hammer assembly includes oscillating means for moving said reciprocating shaft up and down, thereby aiding the insertion of said probe into said ground.

6. A process for eradicating fire ants and other insects dwelling in the ground, comprising:
a. mixing fine particles into a carrier fluid to form a colloid,
b. injecting said colloid into said ground in close proximity to said ants and other insects so as to disperse said fine particles within said ground, so that said fine particles will become entrapped within the joints of said fire ants and other insects, thereby killing said fire ants and other insects.

7. The process as recited in claim 6, wherein said carrier fluid is water.

8. The process as recited in claim 7, wherein said fine particles comprise diatomaceous earth.
